(19) United States
(12) Patent Application Publication
(10) Pub. No.: US 2002/0028130 A1
(43) Pub. Date: Mar. 7, 2002

(54) System for transferring flat bodies

(75) Inventor: Valter Naldi, Torino (IT)

Correspondence Address: ISRAEL GOPSTEIN, Esq., Suite 200C, 14301 Layhill Road, P.O. Box 9303, Silver Spring, MD, 20916-9303, US

(73) Assignee: SELCO SPA

(21) Appl. No.: 09/928,368

(22) Filed: Aug. 14, 2001

Related U.S. Application Data
(63) Continuation of application No. 09/609,639, filed on Jul. 3, 2000, now abandoned.
Application No. 09/609,639 is a continuation of application No. 09/069,167, filed on Apr. 29, 1998, now abandoned.

(30) Foreign Application Priority Data
Apr. 29, 1997 (IT) BO97A 000255

(51) Int. Cl. B65G 59/02

(52) U.S. Cl. 414/796.5

(57) ABSTRACT

A system for transferring flat bodies, wherein an actuating unit transfers the flat bodies in a given direction from a pickup station to an unloading station; a carriage being movable horizontally between the pickup and unloading stations; a pickup member being supported by the first carriage to load blocks of stacked flat bodies at the pickup station; the pickup member having a stop member crosswise to the given direction, and acting as a locator for a block in the given direction; and the actuating unit having a retaining device facing the stop member to limit displacement of the flat bodies on the pickup member during transfer between the pickup and unloading stations.

### BACKGROUND OF THE INVENTION

The present invention relates to a system for transferring flat bodies.

In the furniture industry, systems are used for transferring blocks of flat bodies or panels between side by side work stations, and which comprise at least one powered pickup unit carried movably by a pair of parallel horizontal longitudinal members defining a transfer direction of the pickup unit. The pickup unit in turn comprises a lifting member positionable facing a first work station to pick up a block; and a number of wedge-shaped prongs for supporting the block and equally spaced parallel to the longitudinal members. Each block is fed to the pickup station by a roller conveyor having a number of equally spaced rollers parallel to the longitudinal members, and each of which faces the gap between a respective pair of prongs on the lifting member, so that, once the prongs are fed freely beneath the blocks, the blocks are liftable off the conveyor even when the rollers are operating. The pickup unit also comprises a shoulder crosswise to the prongs and against which the block to be picked up rests. The block is loaded on to the prongs by feeding the pickup unit forwards with the prongs between the rollers; the lifting member is stopped once the shoulder contacts the block; and the pickup unit then lifts the block from the pickup station and transfers it to a second unloading station where the block is unloaded to form a pack of panels.

At the unloading station, the system comprises a horizontal supporting plate for receiving the blocks of panels from the pickup unit, and which is movable vertically to keep the unloading surface at the same height as the blocks are unloaded one on top of the other, and is defined by a first and a second wall crosswise to the longitudinal members and separated by a distance approximately equal to but no less than the width of the panels. More specifically, the first wall is located upstream from the unloading station in the traveling direction of the pickup unit from the pickup station to the unloading station; and the second wall defines a selectively-activated longitudinal stop.

When the block contacts the second wall, the first wall, which has a number of gaps, each for housing a respective prong, is raised and then moved towards the first, so that the first wall compacts and subsequently retains the blocks on the plate as the pickup unit is reversed.

Systems of the above type have several drawbacks, which are particularly noticeable when working with blocks comprising faced panels, i.e. defined by smooth slippery surfaces. That is, as the pickup unit is operating, faced panels simply resting on the prongs and against the shoulder may, for various reasons, slip out of place, so that, in the absence of transverse locators at the unloading station, the blocks cannot be rearranged properly before being unloaded off the prongs. To avoid forming permanently disorderly stacks of panels, the blocks are therefore transferred at low speed, thus reducing the output of the system.

In the event the system comprises a number of unloading stations, the low transfer speed of the pickup unit obviously results in a considerable reduction in the nominal output capacity of the system.

### SUMMARY OF THE INVENTION

It is an object of the present invention to provide a transfer unit designed to eliminate the aforementioned drawbacks.

According to the present invention, there is provided a system for transferring flat bodies, the system comprising at least one pickup station; at least one unloading station; an actuating unit for transferring the flat bodies in a given direction from said pickup station to said unloading station; a powered first carriage movable horizontally between said pickup and unloading stations; and a pickup member carried by said first carriage to load, at said pickup station, at least one block comprising a stack of said flat bodies; said pickup member having a first stop member crosswise to said given direction and which provides for locating a said block in said direction; characterized in that said pickup unit comprises retaining means facing said first stop member to limit displacement of said flat bodies on said pickup member during transfer between said pickup and unloading stations.

### BRIEF DESCRIPTION OF THE DRAWINGS

A non-limiting embodiment of the present invention will be described by way of example with reference to the accompanying drawings, in which:

FIG. 1 shows a schematic view of a system in accordance with the present invention;

FIG. 2 shows a larger-scale front view, with parts removed for clarity, of a first detail in FIG. 1;

FIG. 3 shows a larger-scale plan view, with parts removed for clarity, of FIG. 2;

FIG. 4 shows a larger-scale front view, with parts removed for clarity, of a second detail in FIG. 1;

FIG. 5 shows a larger-scale plan view, with parts removed for clarity, of FIG. 4.

### DETAILED DESCRIPTION OF THE INVENTION

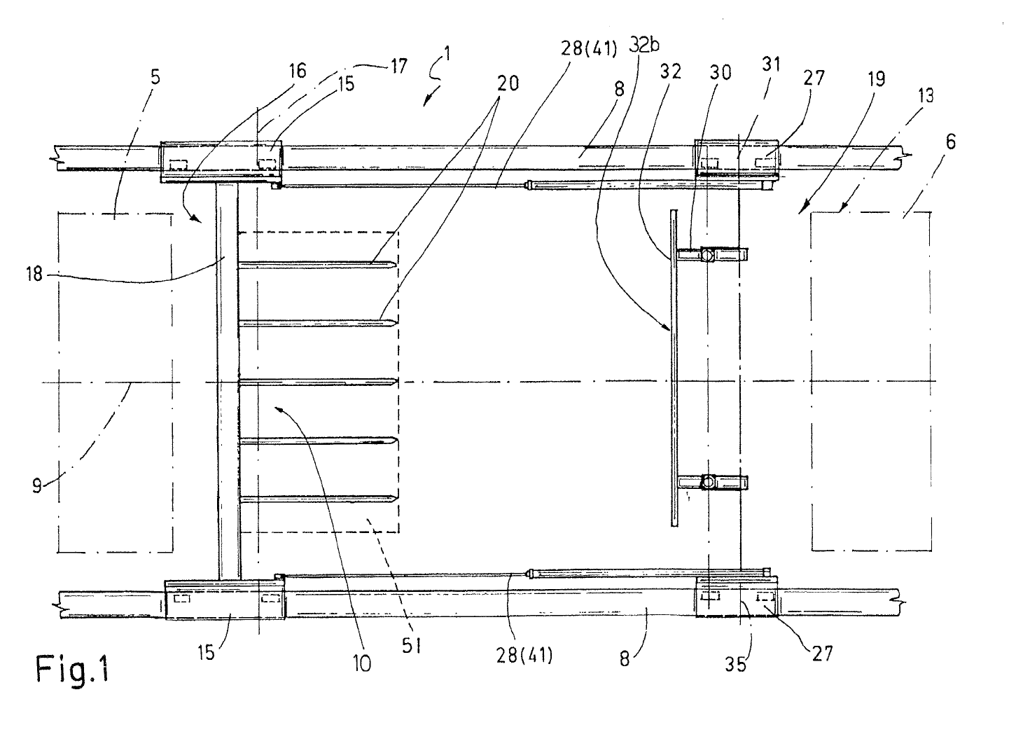

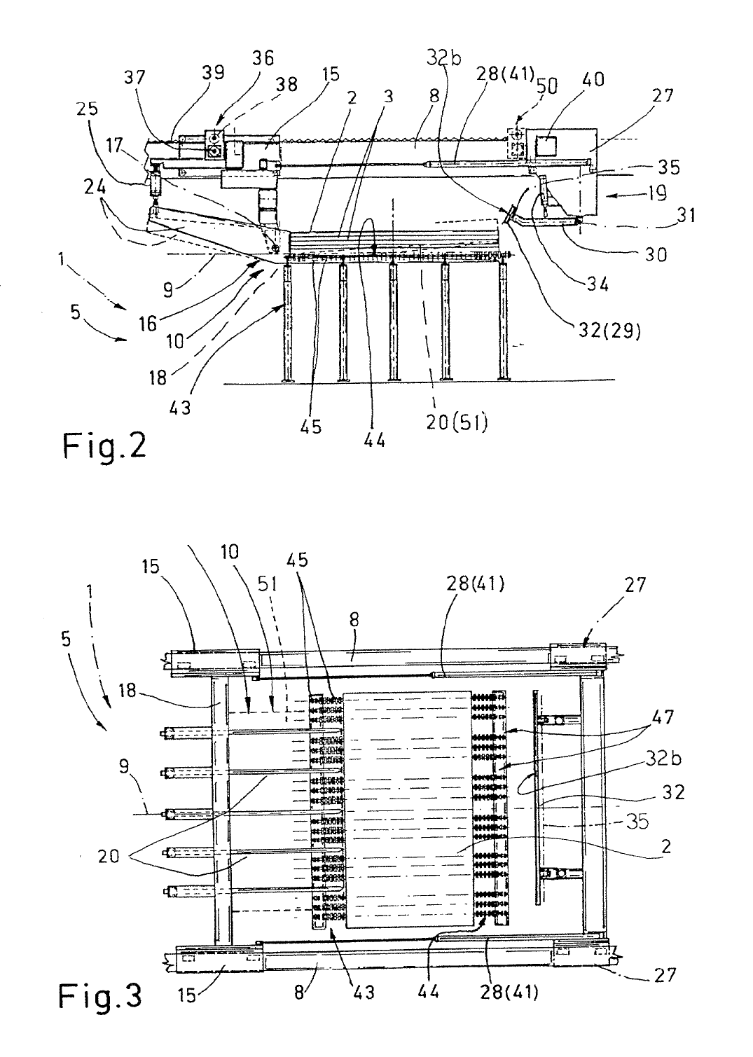

Number 1 in FIG. 1 indicates as a whole a system for transferring blocks 2 of stacked flat bodies 3 (FIG. 2), and which may be used to advantage for picking up and transferring flat bodies 3 between a pickup station 5 and an unloading station 6 arranged side by side. For the sake of simplicity, flat bodies 3 are referred to hereinafter simply as panels 3.

Between pickup station 5 and unloading station 6, the system comprises a pair of parallel horizontal longitudinal members 8 defining a given direction 9. System 1 also comprises a pickup unit 10 supported by longitudinal members 8 so as to slide axially between pickup and unloading stations 5 and 6, and which provides for transferring panels 3 in direction 9.

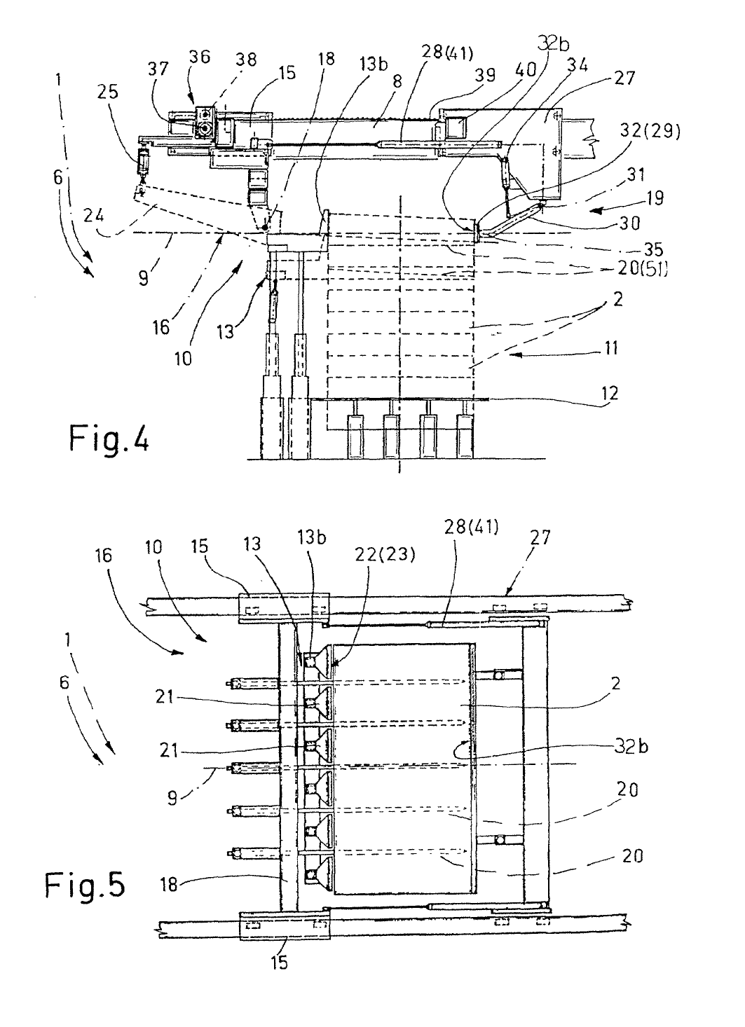

With reference to FIG. 4, unloading station 6 comprises a lift 11 adjustable in height and having a supporting base 12 for receiving blocks 2 downwards from pickup unit 10. Unloading station 6 also comprises a single axial locating device 13, which is movable vertically to and from a position laterally facing a block 2 supported on the pickup unit.

With reference to FIG. 2, pickup unit 10 comprises a pair of carriages 15, each of which is powered and movable along a respective longitudinal member 8 in direction 9; and a pickup member 16 hinged to the two carriages 15 at an axis 17 crosswise to longitudinal members 8. Pickup member 16 comprises a cross member 18 substantially perpendicular to direction 9 and acting as a locating member for each block 2, and therefore provides for loading blocks 2 at pickup station 5 and unloading blocks 2 at unloading station 6. Pickup unit 10 also comprises a retaining device 19 facing cross member 18, and which is movable with respect to carriages 15 to position block 2 firmly contacting cross member 18, and to limit or, selectively, prevent block 2 from moving as the block is transferred between pickup station 5 and unloading station 6.

With reference to FIGS. 1 and 2, pickup member 16 comprises a number of wedge-shaped prongs 20 equally spaced between longitudinal members 8, substantially parallel to direction 9, and which are fed beneath blocks 2 in direction 9 to pick up the blocks. Locating device 13 comprises a wall 13b (FIGS. 4 and 5) movable vertically between a rest position beneath base 12, and a work position laterally facing a block supported on prongs 20 over lift 11. More specifically, wall 13b comprises a number of locators 21 equally spaced crosswise to direction 9 and offset with respect to prongs 20; each locator 21 has a flat face 22 crosswise to direction 9; and the flat faces 22 of locators 21 define as a whole a discontinuous flat surface 23 parallel to cross member 18 and through which prongs 20 travel freely.

On the opposite side of axis 17 to prongs 20, pickup member 16 also comprises a pair of elongated appendixes 24, each connected to a respective carriage 15 by a linear actuator 25 for adjusting as required the angle of pickup member 16, and hence prongs 20, with respect to a horizontal plane.

Retaining device 19 comprises a further pair of carriages 27 (FIGS. 1 and 2), each of which is supported in axially-sliding, angularly-fixed manner by a respective longitudinal member 8, is positioned facing a respective carriage 15, and is connected to respective carriage 15 via the interposition of a respective connecting member 28 adjustable in length in direction 9 to adjust as required the distance between the respective pair of carriages 15 and 27. Between carriages 27, retaining device 19 supports a retaining member 29, which is supported by a pair of substantially identical rocker arms 30 hinged to respective carriages 27 at an axis 31, and is defined by a cross member 32 parallel to cross member 18 and therefore freely rotatable about axis 31. Retaining device 19 also comprises a pair of linear actuators 34, each of which is hinged to a respective carriage 27 and to the corresponding rocker arm 30 by a respective rod, so as to adjust the angular position of cross member 32 as required. It should be pointed out that cross member 32 has a flat surface 32b on the side facing carriages 15; is hinged at the ends to the two rocker arms 30 so as to rotate about an axis 35 parallel to axis 31; and is rotatable about axis 35 by, and to mate laterally with, the block 2 to be gripped.

As shown in FIG. 2, actuators 34 maintain rocker arms 30 substantially horizontal, so that cross member 32 acts as a locator for blocks 2 of panels 3 on prongs 20. Each carriage 15 is moved in direction 9 by a respective linear actuating device 36, which comprises an electric motor 37 supporting a gear 38 which meshes with a rack 39 fitted integrally to respective longitudinal member 8. Each carriage 27 on the other hand carries a brake 40 cooperating with respective longitudinal member 8 and substantially identical to actuating device 36 of the corresponding carriage 15. Pickup member 16 and retaining device 19 therefore define two movable assemblies, which may be operated independently by connecting members 28, each of which normally comprises a linear actuator 41. When carriages 15 are maintained stationary by respective actuating devices 36, only carriages 27 are allowed to move; whereas carriages 15 and 27 may be operated simultaneously when both the motors of actuators 36 and actuators 41 are operated.

Pickup station 5 comprises a conveyor 43 (FIG. 2) for feeding blocks 2 crosswise to direction 9, and which in turn comprises a conveying branch 44 defined by a number of rollers 45 (FIG. 3) parallel to cross members 18 and 32 and offset with respect to prongs 20. Each roller 45 is powered individually, and conveying branch 44, which is therefore discontinuous, comprises a number of gaps 47, each defined by two adjacent rollers 45, and each facing a respective prong 20 so that conveyor 43 receives prongs 20 parallel to direction 9, even when rollers 45 are moving to advance blocks 2.

Operation of system 1 will now be described as of the condition in which rollers 45 of conveyor 43 feed a block 2 of panels 3 towards pickup station 5; the respective rods of actuators 25 of pickup unit 10 are withdrawn so that prongs 20 of pickup member 16 are inclined downwards; and pickup unit 10 is fed towards pickup station 5 by carriages 15. Once block 2 is fed by rollers 45 into the loading position and cross member 18 is moved into a position contacting block 2, prongs 20 are located beneath rollers 45 and actuators 25 are operated to position the upper faces of prongs 20 horizontally and substantially contacting the bottom panel 3 of block 2. Brakes 40 are then deactivated, and connecting members 28 are activated to move cross member 32 of retaining member 29 into lateral contact with block 2 and so clamp the block firmly with panels 3 arranged neatly one on top of the other. The pull exerted by actuators 41 may be adjusted as required according to the mechanical characteristics of panels 3 and the speed and acceleration with which block 2 is conveyed between pickup station 5 and unloading station 6. It should be pointed out that the hinge connection between cross member 32 and rocker arms 30 provides for evenly distributing the pressure over the whole of flat surface 32b and so reducing as far as possible the contact pressure on the edges of block 2.

Once block 2 is gripped between cross members 18 and 32, actuators 41 and 34 are locked, and actuators 25 are operated to raise prongs 20 and so lift block 2 off rollers 45. Once raised, block 2 is transferred to unloading station 6 by simply operating actuators 36.

Once pickup unit 10 is located over unloading station 6, pickup member 16 is rotated in reverse to bring prongs 20 substantially into contact with base 12 or with the block 2 already on base 12. At this point, actuators 34 are operated to rotate cross member 32 and so free block 2 on the opposite side to cross member 18; locating device 13 is then operated to position wall 13b facing block 2 on the side facing cross member 18; and, once brakes 40 are activated to lock carriages 27 in position, actuators 36 reverse pickup member 16 along longitudinal members 8. Surface 23 of wall 13b prevents panels 3 of block 2 from moving backwards, so that pickup member 16 is reversed freely to transfer block 2 from prongs 20 on to lift 11, which, once block 2 is loaded, is lowered to reset the loading level defined by the top panel 3 to the original height.

Clearly, changes may be made to system 1 as described and illustrated herein without, however, departing from the scope of the present invention.

For example, for various reasons, carriages 27 may preferably be movable independently of carriages 15, which may be achieved quite simply by powering each carriage 27 in the same way as each carriage 15 by fitting each carriage 27 with an actuating device 50 substantially identical to actuating device 36, so that carriage 27 is movable along respective longitudinal member 8 in the same way as carriage 15. Being sufficiently described, therefore, actuating device 50 of each carriage 27 is shown simply by the dash line in FIG. 2.

Should the panels 3 for loading be grid-shaped, prongs 20 are preferably replaced by a plate body 51 (shown by the dash line in FIGS. 1, 2, 4) of a width approximately equal to but no greater than the width of cross member 18. To simplify the loading of blocks 2 by plate body 51, this may conveniently be shaped with a constant wedge-shaped cross section similar to prongs 20.

For various reasons, cross member 32 may conveniently be fitted to carriages 27 via the interposition of a pair of linear actuators to adjust the vertical position of the cross member directly. The rods of the linear actuators would, of course, have to support cross member 32 by means of cylindrical articulations to enable cross member 32 to rotate about axis 35.

Retaining device 19 may also be used to limit the maximum permissible displacement of panels 3 on prongs 20 (or body 51) during transfer between pickup station 5 and unloading station 6, by limiting the movement of cross member 32 towards cross member 18 so as to lock cross member 32 at a given distance, definable as required, from panels 3. To simplify the above application, provision may conveniently be made for a proximity sensor on cross member 32.

1) A system (1) for transferring flat bodies (3), the system (1) comprising at least one pickup station (5); at least one unloading station (6); an actuating unit (10) for transferring the flat bodies (3) in a given direction (9) from said pickup station (5) to said unloading station (6); a powered first carriage (15) movable horizontally between said pickup and unloading stations (5, 6); and a pickup member (16) carried by said first carriage (15) to load, at said pickup station (5), at least one block (2) comprising a stack of said flat bodies (3); said pickup member (16) having a first stop member (18) crosswise to said given direction (9) and which provides for locating a said block (2) in said direction (9); characterized in that said pickup unit (10) comprises retaining means (19) facing said first stop member (18) to limit displacement of said flat bodies (3) on said pickup member (16) during transfer between said pickup and unloading stations (5, 6).

2) A system as claimed in claim 1, characterized in that said retaining means (19) comprise a second stop member (32) facing said first stop member (18); said second stop member (32) being movable to and from said first carriage (15) to move a said block (2) firmly into contact with said first stop member (18) and to keep the block clamped against the first stop member during transfer between said pickup and unloading stations (5, 6).

3) A system as claimed in claim 2, characterized by also comprising at least one longitudinal member (8) located over and crosswise to said pickup and unloading stations (5, 6); said first carriage (15) being supported in axially-sliding, angularly-fixed manner by said longitudinal member (8); said retaining means (19) comprising a second carriage (27) supported in axially-sliding, angularly-fixed manner by said longitudinal member (8); and said second carriage (27) facing said first carriage (15) and being connected to the first carriage via the interposition of a connecting member (28) adjustable in length to adjust as required the distance between said first and second carriage (15, 27).

4) A system as claimed in claim 3, characterized in that said pickup member (16) is hinged to said first carriage (15) beneath said longitudinal member (8) to rotate about a first axis (17) crosswise to said longitudinal member (8).

5) A system as claimed in claim 4, characterized in that said pickup member (16) has a number of equally spaced wedge-shaped prongs (20) crosswise to said first stop member (18).

6) A system as claimed in claim 4, characterized in that said pickup member (16) has a plate body (51) of a transverse extension approximately equal to the transverse extension of said first stop member (18).

7) A system as claimed in claim 5, characterized in that the prongs (20) are crosswise to said first axis (17); said second stop member (32) being carried by said second carriage (27) and facing said first stop member (18).

8) A system as claimed in claim 7, characterized in that said first carriage (15) has respective first actuating means (36) for moving said pickup member (16) along said longitudinal member (8) between said pickup station (5) and said unloading station (6); said connecting member (28) being a first linear actuator (41) located between said first and second carriage (15, 27) to move said second carriage (27) to and from said first carriage (15).

9) A system as claimed in claim 8, characterized in that said first carriage (15) supports a first actuating member (25) connected to said pickup member (16) on the opposite side to said prongs (20); said first actuating member (25) rotating said pickup member (16) about said first axis (17); said pickup member (16) having a first appendix (24) located beneath said longitudinal member (8) on the opposite side to said prongs (20); and said first actuating member (25) being a second linear actuator (25) supported by said first carriage (15) and having a first rod hinged to said first appendix (24).

10) A system as claimed in claim 8, characterized in that said second carriage (27) supports a second actuating member (34) connected to said second stop member (32) on the opposite side to said connecting member (28), and for rotating said second stop member (32) about a second axis (31) parallel to said first axis (17).

11) A system as claimed in claim 8, characterized in that said second carriage (27) carries a hinged second appendix (30) beneath said longitudinal member (8) on the opposite side to said prongs (20); said second actuating member (34) being a third linear actuator (34) supported by said second carriage (27) and having a second rod hinged to said second appendix (30).

12) A system as claimed in claim 8, characterized in that said second stop member (32) is supported by said second carriage (27) by means of actuating means for adjusting the distance between the second stop member and said longitudinal member (8) as required.

13) A system as claimed in claim 8, characterized in that said second stop member (32) is rotated by a said block (2) about a third axis (35), parallel to said second axis (31), to mate laterally with said block (2).

14) A system as claimed in claim 2, characterized by comprising at least one longitudinal member (8) located over and crosswise to said pickup and unloading stations (5, 6); said first carriage (15) being supported in axially-sliding, angularly-fixed manner by said longitudinal member (8); said retaining means (19) comprising a second carriage (27) supported in axially-sliding, angularly-fixed manner by said longitudinal member (8); and said second carriage (27) being movable to and from said first carriage (15) by respective drive means (50).

15) A system as claimed in claim 1, characterized in that said unloading station (6) comprises a support (11) adjustable in height and for receiving said blocks (2) downwards; said unloading station (6) having a single longitudinal locating member (13b) movable vertically to and from a position laterally facing a block (2) of flat bodies supported by said pickup member (16); said locating member (13b) having a number of locators (21) equally spaced crosswise to said given direction (9); each said locator (21) having a flat face (22) crosswise to said direction (9); the flat faces (22) defining, as a whole, a flat discontinuous locating surface (23); and said locators (21) being so spaced as to freely receive said prongs (20) in between.
